(19) United States
(12) Patent Application Publication
(10) Pub. No.: US 2012/0124841 A1
(43) Pub. Date: May 24, 2012

(54) Tool for cutting armor of cables

(75) Inventor: Lucien Ducret, Stamford, CT (US)

(73) Assignee: SEATEK Co. Inc, Stamford, CT (US)

(21) Appl. No.: 12/927,668

(22) Filed: Nov. 22, 2010

(51) Int. Cl. H02G 1/12

(52) U.S. Cl. 30/90.1

(57) ABSTRACT

A portable tool for cutting an armor of a cable is configured with two clamping units pivotally mounted to one another swing between an open position in which the desired blade penetration depth into the armor is set, and a closed position in which the cable is engaged for producing a cut. One of the clamping units supports a stop unit configured with a screw mounted to the one clamping unit and extending transversely to the rotation axis of the blade. The stop unit further has a bracket traversed by the screw, and a pin traversed by and threaded on the screw and mounted within the bracket. The stop unit further has a stroke-adjusting nut threaded on the screw and operative to actuate relative displacement between the bracket and pin so as to set the desired penetration depth and control the displacement of the blade into the armor at the desired depth.

### BACKGROUND OF THE DISCLOSURE

1. Filed of the Disclosure

The disclosure relates to motorized tool operative control displacement of a blade into the armor so as to prevent damage to the core of the cable.

2. Known Prior Art

Numerous tools configured to produce a cut across the armor are known. Besides effectively cutting the armor, the known tools are configured with a depth penetration control mechanism operative to prevent a blade from cutting into the core of the cable. Each of the known tools has its advantages and disadvantages the latter of which are dealt with by the disclosed tool.

### SUMMARY OF THE DISCLOSURE

The disclosed tool for producing a cut in armored cable is operative to allow the operator to set a desired depth penetration of saw blade and further control the penetration of the saw blade while cutting the armor so that it stops at the desired depth.

In accordance with one aspect, the portable tool includes a stop unit mounted on one of two clamping units which are hinged to one another. The stop unit is configured with multiple components displaceable relative to one another so that initially the desired depth is set and is further controlled.

In accordance with another aspect of the disclosure, the tool has a friction adjustment unit configured to tighten the clamping units relative to one another when the units are swung to a closed position in which they engage the cable to be cut. The friction adjustment unit is pivotally mounted on one of the clamping units and is operative to engage the other clamping unit in the closed positions of the units so that the cable is displaceably fixed during the cut.

In accordance with a further aspect of the disclosure, one of the clamping units is configured with resilient components facing the other clamping unit when the units are swung to one another to the closed position. The resilient components urge against the cable minimizing the possibility of damage to the cable when the friction adjustment unit is actuated.

### BRIEF DESCRIPTION OF THE DRAWINGS

The above and other features are discussed hereinbelow in conjunction with the accompanying drawings, in which:

FIG. 1 is an isometric view of the disclosed tool;

FIG. 2 is an exploded view of the stop unit of the disclosed tool;

FIG. 3 is an exploded view of the disclosed adjustable friction unit;

FIG. 4 is an isometric view of one of the clamping units of the tool shown in FIG. 1; and

FIG. 5 is an isometric view of a motorized blade unit of the disclosed tool.

### SPECIFIC DESCRIPTION

Reference will now be made in detail to the disclosed device. Wherever possible, same or similar reference numerals are used in the drawings and the description to refer to the same or like parts or steps. The drawings are far from precise scale. The directional terms “up, down, top, lower” and the like should be considered only relative to the plane of the drawing sheet. The terms “couple, connect” and the like do not necessarily indicate a direct engagement between components.

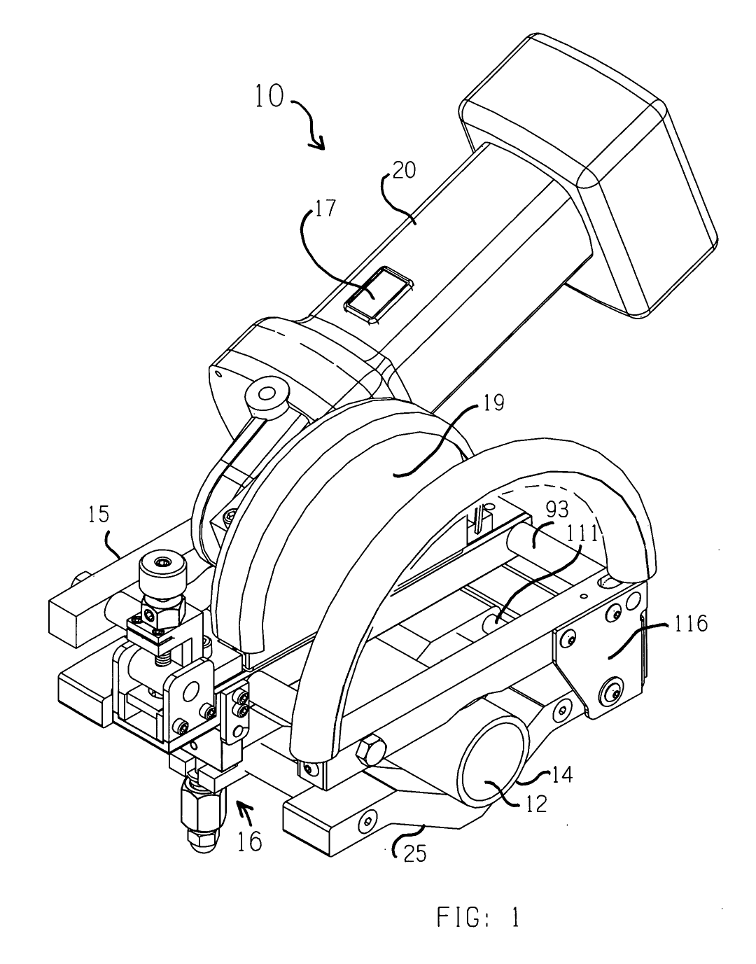

FIG. 1 illustrates the disclosed tool 10 configured to controllably cut outer steel armor 14 of a cable 12 so as to prevent damaging the core of the latter. The tool 10 includes a base configured with clamping units 15 and 25, respectively, further referred to as low and upper clamping units, respectively. The low clamping units 25 and upper unit 15 rotatably mounted on respective shafts 93 and 111, which are spaced apart and both journaled to a pair of spaced flanges 116, so as to pivot relative to one another between open and closed positions. When the blade penetration depth is set, as explained below, clamping units 15 and 25, respectively, are brought towards one another to engage cable 12 in the closed position. The latter is realized by an adjustable friction system 16 disclosed in greater detail below. In general, units 15 and 25 are brought towards one another until cable 12 is reliably sandwiched between the opposing surfaces of respective clamping units 15 and 25. The friction system 16, pivotally mounted to upper clamping unit 15, is swung towards and engages lower unit 25 so as to prevent displacement of the clamping units away from one another and further tighten them to ensure the reliable clamping of cable 12. The bottom surface of upper clamping unit 15 is provided with resilient components 18 pressing upon cable 12 so as to compensate for the cable longitudinal curvature so as to keep platen 92 in contact with the outer surface of cable 12. The component 18 may include leaf springs, plastic or rubber pads, compression spring and the like.

In operation, the user first brings a blade to a position in which it rests on armor 14 of the clamped cable, and further actuates a motor driving a saw blade unit 19 by depressing a switch 17 on a motor housing 20. As entire tool 10 rotates about cable 12, a blade of blade unit 19 penetrates the armor of cable 12 progressively at the desired depth, as explained immediately below.

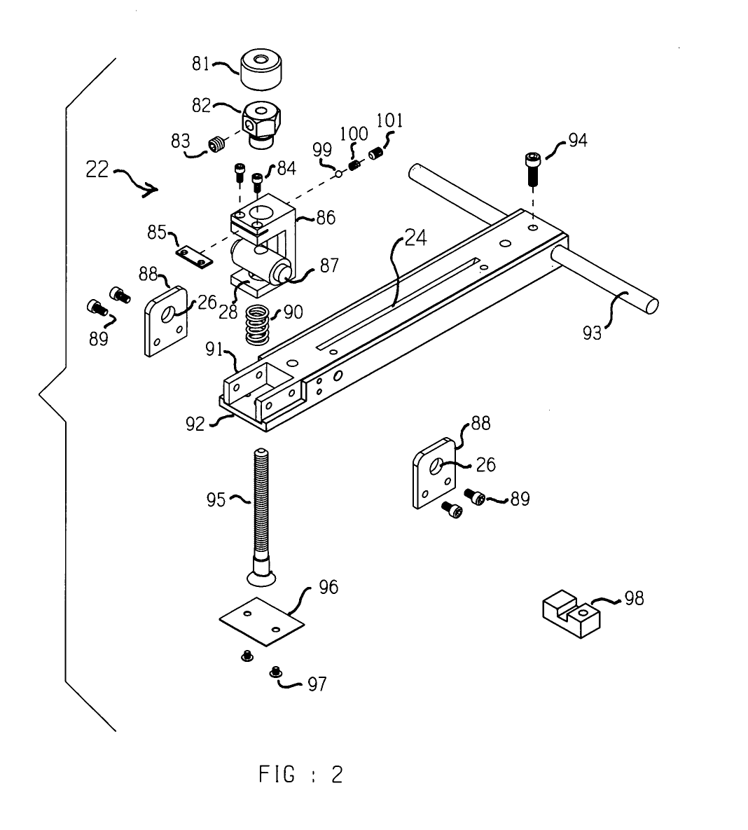

FIG. 2, considered in combination with FIG. 1, illustrates the operation of a stop unit 22 mounted to upper clamping unit 15 and configured to arrest the penetration of the blade at the desired depth and controllably remove the blade from cable 12 after the cut has been completed. The unit 22 includes a support configured with a platen 92 and an arm 91 which is pivotal relative to platen 92 with shaft 93 to which the arm is rotatably fixed by a screw 94. The arm 91 is provided with a slit 24 dimensioned to be slightly greater than the blade. The platen 92 may also have a slit in its bottom, or the latter can be open downwards. The stop unit 22 is operative to set the desired blade penetration depth in accordance with specified parameters of cable 12, such as the thickness of armor 14.

To set the desired blade penetration depth, upper and lower clamping units 15 and 25, respectively, are swung away from one another. Then, the operator removably mounts one of a plurality of gages 98, which have respective differently dimensioned recesses the depth of which correspond to respective specified thicknesses of armor 14, to the bottom of platen 92. To displace the blade towards mounted gage 98, the operator actuates a nut 81 which is fixed to a screw 95 having a top sandwiched between the free end of platen 92 and a support plate 96 which are coupled together by screws 97. The manipulation of nut 81 translates to the angular displacement of entire upper clamping unit 15 relative to platen 92 and thus causes the blade to move towards the bottom of the recess provided in gage 98. Once the blade rests on the bottom of the gage's recess, the desired penetration depth corresponding to the thickness of armor 14 of cable 12 is set.

The established position of the saw blade is not fixed yet for actual cutting of armor 14 (FIG. 1), since clamping units 15 and 25 have to engage now cable 12. To ensure that the displacement of the blade is indeed stopped in the desired blade position during actual cutting of the cable, stop unit 22 is operative to control and stop further displacement of the blade once the latter penetrates armor 14 at the set depth.

The stop unit 22 includes a depth indicator which, for example, may have a C- or U-shaped bracket 86, traversed by screw 95, and a pin 87 whose pin axis extends parallel to the axis of blade rotation and transversely to the longitudinal axis of screw 95. The pin 87 is mounted on and displaceably fixed to arm 91 and has a central passage threadedly engaged by screw 95. The mounting system of pin 87 includes a pair of spaced flanges 88 which are coupled to the distal end of the arm 91 by fasteners 89. The flanges 88 are mounted so that respective bores 26 are in a concentric position which allows pin 87 to be journaled in these bores.

As disclosed above, the actuation of knob 81 causes the upper clamping unit 15 to lower to the desired blade penetrating position in which the blade is rested on the bottom of the recess provided in gage 98 that may or may not be detached from platen 92 upon establishing this position. The stop position of the blade is set when pin 87 and a bottom shelf 28 of bracket 86 come into contact. Accordingly, to fix the desired penetration depth, the operator first loosens a screw 83, actuates a nut 82 threaded on screw 95 and fixed to bracket 86 which moves upwards relative to pin 87. The synchronous displacement of nut 82 and bracket 86 is realized by a stop plate 85 which is inserted into a recess on bracket 86 so as to engage nut 82. However, plate 85, which is fixed to bracket 86 by screws 84, does not preclude rotation of nut 82 relative to screw 95 which continues until bracket 86 moves along screw 95 to a position in which bottom shelf 28 of bracket 86 urges against pin 87. To ensure that nut 82 does not rotate accidentally, a biasing mechanism, including ball 99, spring 100 and set screw 101, is mounted to bracket 86 and operative to exert a dragging force upon nut 82. At this point, the position of nut 82 and bracket 86 on screw 95 is secured by set screw 83. The knob 81 is actuated again causing pin 87 and the components coupled to arm 91 to move in the opposite direction until the upper shelf of bracket 86 thereof comes into contact with pin 87. In response to the applied torque, knob 81 causes the blade to retract. The clamping units are ready now to move to the closed position thereof and engage the cable so as to commence the cutting operation. During cutting, a spring 90, penetrating an opening in low shelf 28 of C-shaped bracket 86 so as to be in contact with pin 87, biases the latter away from the flat top of screw 95 which substantially neutralizes a backlash.

To summarize the sequence of steps leading to setting the desired depth penetration of the blade, the operator rotates knob 81, for example, clockwise along with screw 95. The torque applied to screw 95 which has, for example a left-hand thread, causes pin 87 and, therefore, arm 91 and blade unit 19 to move downwards until the saw blade rests on the recess's bottom of gage 98. After that, set screw 83 is backed up, nut 82 is actuated to rotate clockwise causing C-shaped bracket 86 to move upwards relatively to pin 87 until the contact between the lower segment of pin 87 and lower shelf 28 is established. This position is registered with set screw 83 being tightened up. Afterwards knob 81 rotates in the direction opposite to the initial one displacing arm 91, pin 87 and saw unit 19 upwards, but the position of nut 82 and bracket 86 on screw 95 is fixed. Finally, cable 12 is received and tightened by friction unit 16 between clamping units 15 and 25 which are coupled to one another by the same friction adjustment unit 16, as explained below.

The operator, then, applies a torque to nut 81 so that the latter rotates in the initial clockwise direction. The saw unit 19 is displaced towards platen 92 causing the saw blade to penetrate armor 14 of cable 12. As low shelf 28 of bracket 86 comes in contact with pin 87, the displacement of the saw blade is arrested at the set depth. To remove the blade from cable 12, the operator again changes the rotational direction of knob 81 causing arm 91 and pin 87 to move upwards. Once pin 87 is in contact with the upper shelf of bracket 86, the blade is retracted from armor 14.

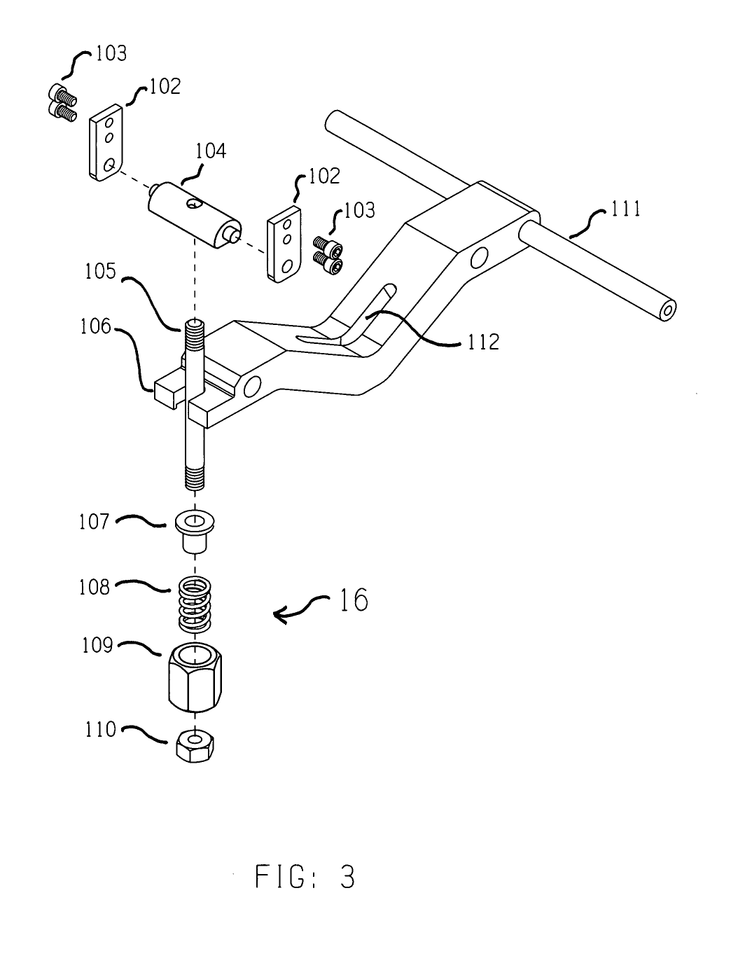

FIG. 3 considered here in combination with FIGS. 1 and 2, illustrates the cable support which is part of low clamping unit 25. The support unit includes a plurality of spaced apart along the longitudinal axis of cable 12 V- or U-shaped frames 106. The frames 106 each or selective ones may be provided with a recess 112 allowing the operator to view the machining of armor 14 of cable 12 (FIG. 1). The ends of respective frames 106 are mounted to shaft 111 which in turn is coupled to brackets 116 (FIG. 1) of low clamping unit 25.

The support unit further has friction adjustment unit 16 configured to couple clamping units 15 and 25, respectively. The unit 16 includes a stud 105 slidably received in a recess which is provided in a free end of middle V-shaped frame 106 opposing platen 92 of FIG. 2. A spring 108 slides over busing 107, which is traversed by stud 105, until the spring presses against the underneath of the recessed end of frame 106. The opposite end of spring 108 is received in a seat of hexagonal nut 109 which is threaded to one of the ends of stud 105. A cap 110 is fixed to the end of stud 105 to prevent the above-disclosed components of the adjustment unit to accidentally disengage one another. The other threaded end of stud 105 is threaded into a semicircular bridge 104 journaled on two opposite upright brackets 102, which, in turn, are fastened to the opposite sides of platen 92 (FIG. 2) of the stop unit by respective screws 103.

In the open position of clamping units 15, 25, respectively, friction unit 16 is swung upwards to displace stud 105 out of the recessed end of V-shaped middle frame 106. The operator then displaces clamping units 15 and 25, respectively to receive cable 12 and pivots stud 105 downwards into the recessed end of V-shaped frame 106 coupling, thus, both clamping units together. The operator further tightens nut 109 until sufficient friction is generated between cable 12 and the seat of V-shaped frames 106.

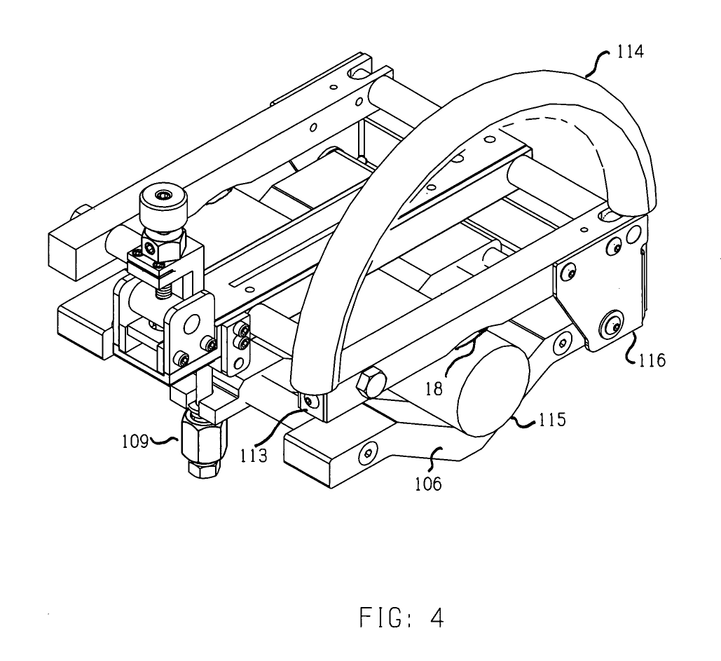

FIG. 4 illustrates a slight modification of tool 10 specifically adjusted for small-diameter cables 115. In particular, a rubber handle 114 mounted on supports 113 of the upper clamping unit can be used by the operator to rotate and guide tool 10 around cable 115. The V-shaped seats of respective frames 106 of the low clamping unit are configured with a cable diameter acceptance limited by the travel of nut 109 and support cable 115 pressed downwards by platen 92.

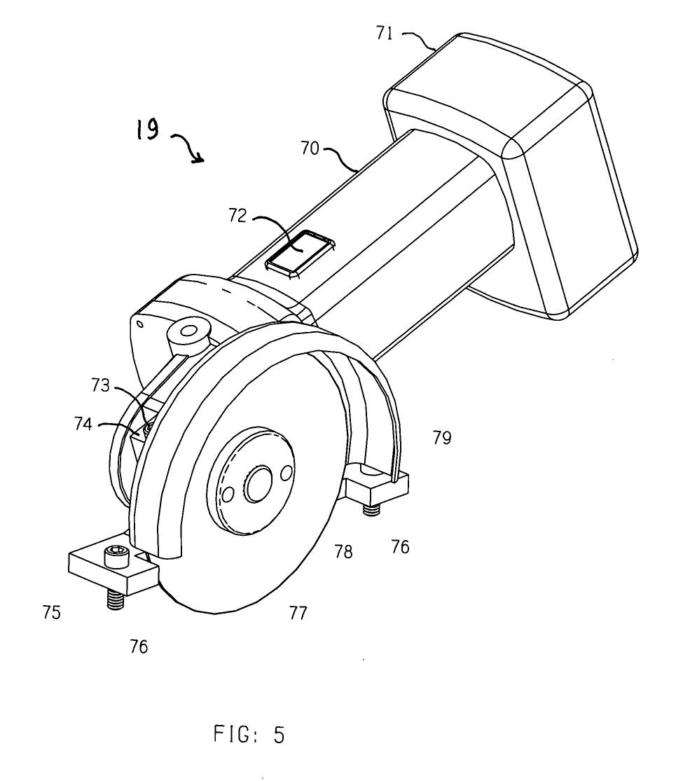

FIG. 5, explained in conjunction with FIG. 1, shows motor housing 70 coupled to the saw unit and upper clamping unit 25. One end of housing 70 is mounted to a support 75 by means of upper clamp 74 screwed to housing 70 by fasteners 73. The clamp 74 is supported on support 75 screwed to upper clamping unit 25 by fasteners 76. The opposite end of housing 70 is provided with a housing receiving a rechargeable battery which energizes the blades motor upon depressing a switch 72. A saw unit includes a blade 78 mounted on a shaft 77 which is coupled to the motor. The protective cover 79 prevents direct contact with blade 78.

While this disclosure has described various aspects of the present invention, the latter is not limited thereto, and is susceptible to numerous changes and modifications as known to those skilled in the art. Therefore, the invention is not limited to the details shown and described herein, and includes all such changes and modifications as are encompassed by the scope of the appended claims.

1. A portable tool for cutting an armor of a cable, comprising:
a base;
a blade mounted to the base and rotatable about a rotation axis parallel to a longitudinal axis of the cable;
a stop unit operative to set a desired blade penetration depth into the armor and configured with:
a screw mounted to the base and extending transversely to the rotation axis,
a bracket traversed by the screw,
a pin traversed by and threaded on the screw and mounted within the bracket; and
a stroke-adjusting nut threaded on the screw beyond the bracket and operative to actuate relative displacement between the bracket and pin so as to set the desired depth corresponding to a specified thickness of the armor.

2. The portable tool of claim 1, wherein the base includes:
two spaced flanges flanking one side of the base; and
two clamping units operative to pivot relative to one another about respective spaced shafts, which extend parallel to the rotation axis and journaled to the flanges, between an open position and a closed position in which the units engage the cable.

3. The portable tool of claim 2, wherein the blade and stop unit are mounted to one of the clamping units, the stop unit having:
a platen displaceably fixed to the one clamping unit and rotatably mounted on one of the shafts,
an arm having one end mounted rotatably fixed to the one shaft so as to pivot relative to the platen, the arm being received in the platen in one of extreme positions thereof, the arm and platen having respective free ends traversed by the screw so that the arm and pin are displaceably fixed relative to one another.

4. The portable tool of claim 3 further comprising a plurality of gages having respective differently dimensioned recesses, upon selecting one of the gages with a depth of the recess corresponding to the specified thickness of the armor of the cable, the selected gage being removably mounted to a bottom of the platen in the open position of the clamping units, the arm having a slit traversable by the blade as the latter lowers toward the bottom of the recess in response to a torque applied to the screw, the torque being ceased when the blade rests on the bottom of the recess signaling the setting of the desired blade penetration depth.

5. The portable tool of claim 4, wherein the bracket has shelves spaced from one another along the screw, upon setting the desired blade penetration depth in the open position of the clamping units the stroke-adjusting nut of the stop unit being actuated so as to cause the bracket to move relative to the pin until the latter rests on one of the shelves while the blade is resting on the recessed bottom of the gage.

6. The portable tool of claim 5, wherein the stop unit further has:
a stop plate received in a slit which is provided in the bracket and engaging the nuts so as to prevent linear displacement between the bracket and the nut but allow the nut and screw to rotate relative to one another, and
a set screw coupling the stroke adjusting nut to the screw so as to prevent relative linear displacement thereof upon pressing the one shelf against the pin.

7. The portable tool of claim 6, wherein the bracket further has a knob fixed to a free end of the screw and actuating the screw to rotate in one direction upon setting the desired blade penetration depth so that the blade, arm and the pin are displaceable relative to the racket until the pin urges against other shelf of the bracket in the open position of the clamping units.

8. The portable tool of claim 7, wherein the clamping units are swung to the closed position to engage the cable placed on the other clamping unit upon contact between the pin and other shelf of the bracket, the knob being again actuated to cause the arm and bracket to displace relative to the platen so as to rest the one shelf on the pin and arrest displacement in a position corresponding to the penetration of the blade at the desired depth into the armor of the cable.

9. The portable tool of claim 3, wherein the stop unit further has two flanges displaceably fixed to the free end of the arm and having the pin mounted to the flanges so as to displaceably fix the arm and the pin, the free end of the arm having a U-shaped recess configured so that the bracket rests on the free end of the platen.

10. The portable tool of claim 9, wherein the stop unit further has
a support plate fastened to an outer surface of the free end of the platen so as to have a top of the screw sandwiched therebetween, and
a resilient element resting on an inner surface of the platen and traversing the bracket to press against the pin so as to eliminate a backlash.

11. The portable tool of claim 1, wherein the bracket has a threaded opening receiving a ball, a spring and a set screw pressing against the spring so as to provide a dragging force upon the stroke adjusting nut received within the bracket.

12. The portable unit of claim 8, wherein the other clamping unit has a plurality of V-shaped frames spaced from one another along the longitudinal axis of the cable which is rested on the V-shaped frames.

13. The portable tool of claim 12, wherein the one clamping unit has a plurality of resilient components protruding towards a V-shaped formation on the V-shaped frame, the resilient components pressing against the cable in the closed position of the clamping units and configured to compensate for a longitudinal curvature of the cable prevent the cable from being damaged while maintaining contact between the platen and cable.

14. The portable tool of claim 13, wherein the resilient components each is selected from the group consisting of leaf springs, compression springs, rubber and plastic pats.

15. The portable tool of claim 13 further comprising an adjustable friction unit pivotally mounted to the one clamping unit and operative to engage one of the V-shaped frames in a locking position so as to tighten the clamping units relative to one another in the closed position thereof such that the cable is displaceably fixed to the V-shaped formations.

16. The portable tool of claim 15, wherein the adjustable friction unit includes a pair of uprights detachably coupled to the one clamping unit, a pin rotatably mounted between the uprights, and a stud provided with opposite threaded ends one of which is coupled to the pin so as to rotatably actuate the latter in response to an external force.

17. The portable tool of claim 16, wherein the stud traverses a recess provided in a free end of the one V-shaped frame in the locking position of the friction unit.

18. The portable tool of claim 17, wherein the friction unit further has
a flanged bushing slidable over an other end of the stud opposite to the one end pivotally mounted to the one clamping unit, the other end of the stud nesting in the recess of the one V-shaped frame in the locking position of the friction unit,
a spring slidable over the bushing to have one of opposite ends thereof urge against the free end of the V-shaped frame, and
a hexagonal nut screwed on the other end of the stud and receiving the other end of the spring, the one V-shaped frame having a slot configured to provide visual control of the cut. The portable tool of claim 18 further comprising a support handle mounted to the one clamping unit and operative to rotate the clamping units about the cable, wherein the V-shaped formations each have a cable diameter acceptance limited by a travel of the hexagonal nut.

20. The tool of claim 1 further comprising a motor coupled to the one clamping unit and operative to actuate the blade.
